(19) United States
(12) Patent Application Publication
(10) Pub. No.: US 2005/0069475 A1
(43) Pub. Date: Mar. 31, 2005

(54) System and process for reducing impurities

(76) Inventors: Daniel B. Hage, Burnet, TX (US); Robert Jackson, Burnet, TX (US)

Correspondence Address: SPRINKLE IP LAW GROUP, 1301 W. 25TH STREET, SUITE 408, AUSTIN, TX, 78705, US

(21) Appl. No.: 10/675,579

(22) Filed: Sep. 30, 2003

(51) Int. Cl. C01B 3/00; C25C 1/24; H01M 10/44

(52) U.S. Cl. 423/210; 205/619; 429/50

(57) ABSTRACT

An impurity gettering device can be installed between a source and a reactor to reduce an impurity from a fluid before it reaches the reactor. More particularly, the impurity gettering device can getter an inorganic, polar, hydrogen-containing impurity (e.g., H₂O, NH₃, etc.) from a halogen-containing fluid (e.g., a fluorine-containing liquid or gas) by forming ligands to a metal-containing compound to form a complex. In one example, a fluid source may include HF and H₂O, which can flow through the impurity getting device that includes COF₂. The COF₂ can getter the H₂O and form CoF₂.ZH₂O, where Z is an integer. The fluid may become anhydrous HF that can be processed by a reactor, such as an electrolytic cell. By removing H₂O before the fluid reaches the electrolytic cell, adverse effects of H₂O, such as consumption of a carbon anode, particle generation, etc. can be reduced.

### RELATED APPLICATIONS

This application is related to U.S. patent application Ser. No. 10/038,745 entitled “Method And System For On-Site Generation And Distribution Of A Process Gas” by Jackson filed of Jan. 2, 2002; Ser. No. 10/193,864 entitled “System and Method for On-Site Generation and Distribution of Fluorine for Fabrication Processes” by Siegele et al. filed on Jul. 12 2002; and Ser. No. 10/283,433 entitled “Generation and Distribution Of Molecular Fluorine Within a Fabrication Facility” by Siegele et al. filed on Oct. 30, 2002, all of which are assigned to the current assignee hereof and are incorporated herein by reference.

### FIELD OF THE INVENTION

The present invention generally relates to impurity gettering devices, and more particularly, to impurity gettering devices and processes of using them to remove impurities from halogen-containing fluids.

### DESCRIPTION OF THE RELATED ART

The use of diatomic fluorine within semiconductor processing equipment is now gaining more popularity. One way to generate diatomic fluorine is to dissociate hydrogen fluoride (HF) within an electrolytic cell to generate diatomic hydrogen and diatomic fluorine. Within the electrolytic cell, a carbon anode may be used. During operation of the cell, a passivation layer, composed of Cₓ⁺HF₂⁻, which is a graphitic intercalation compound, where x>0, may form on the carbon anode to protect the surface of the anode.

Typical commercial specifications for HF allow for 100-200 parts per million (ppm) of water. This level of water can cause problems within an electrolytic cell. The water can decompose into hydrogen and oxygen before the HF decomposes into hydrogen and fluoride. The oxygen from water can cause problems with the operation of the cell. Oxygen within the cell can form carbon oxyfluorides, sulfur oxyfluorides, and a number of other compounds. These compounds may be in the form of particulates that exit the cell with the diatomic fluorine. The entrained particulates may clog or otherwise significantly inhibit gas flow through a downstream filter. Further, the oxygen can react with the graphitic carbon anode to form an undesirable coating of graphite oxide (CₓO)ₙ, where x>0 and n is an integer greater than zero. In the presence of fluorine, this graphite oxide can be converted to an undesirable, insulating form of graphite fluoride, (CFₓ)ₙ. This compound has low electrical conductivity and can cause increased voltage requirements at the anode-electrolyte interface. Its low surface energy reduces wetting between the electrolyte and anode surface, thus further increasing voltage requirements at the anode-electrolyte interface, reducing chemical exchange across this interface and creating localized regions of high anode temperature. Further, the graphite fluoride (CFₓ)ₙ, is unstable and reacts with fluorine to produce an undesirable gaseous byproduct, carbon tetrafluoride, CF₄, thereby exposing additional elemental carbon of the carbon anode. The oxygen can also consume carbon by forming carbon monoxide, carbon dioxide, or potentially other compounds. Alternatively, a new passivation layer may form along the surface, thus consuming more carbon from the anode. Regardless of the mechanism, consumption of the carbon anode can significantly reduce the operating life of the electrolytic cell.

A number of methods currently exist for removing water from fluids. Many of these water removal systems are not well suited when a fluorine-containing compound is involved. An undesired reaction between fluorine and the gettering material, which is to getter the water, may occur.

In one attempt to solve the problems with the electrolytic cell, a potassium fluoride salt may be added to the hydrogen fluoride to help tie up any water within the cell. This attempt works poorly because it does not remove water before reaching the cell. Therefore, the problems seen with consumption of a carbon anode may still occur since water is allowed to enter the electrolytic cell.

Problems are not limited to the electrolytic cells. Although most fabrication facilities have very high purity gases sources, these high purity gases sources may have contaminants introduced within processing gas lines due to fittings or other potential leaks that may inadvertently introduce air, oxygen, or water into a processing system. This problem may be amplified if the process gas lines are under vacuum.

For example, if oxygen is mixed with a fluorine-containing gas that is to become part of a plasma, fluorine within the plasma may have a reduced lifetime due to the presence of oxygen. Further, if an organic layer, such as a patterned resist layer is present during an etching step of a fabrication process, the presence of oxygen may erode in some of the resist layer. As the need for thinner resist layers to more accurately patterned underlying layers increases, the ability to etch those underlying layers while minimizing resist erosion becomes more important.

### SUMMARY

An impurity gettering device can be installed between a source and a reactor to reduce an impurity from a fluid before it reaches the reactor. More particularly, the impurity gettering device can getter an inorganic, polar, hydrogen-containing impurity (e.g., water, ammonia, etc.) from a halogen-containing fluid (e.g., a fluorine-containing liquid or gas) by forming ligands to a metal-containing compound to form a complex. In one example, a fluid source may include hydrogen fluoride and some water. The hydrogen fluoride and water can flow through the impurity gettering device that includes cobalt difluoride. The cobalt difluoride can getter the water and form a cobalt difluoride hydrate. After removing or at least reducing the level of water in the fluid stream, the hydrogen fluoride may become anhydrous hydrogen fluoride that can be processed by a reactor, such as an electrolytic cell. By reducing the water level before the fluid reaches the electrolytic cell, adverse effects of water, such as consumption of a carbon anode, particle generation, etc. can be reduced.

The impurity gettering material may be regenerated by removing the ligand (e.g., water or ammonia) from the complex. If the impurity is water, the impurity gettering material may be dehydrated. The regeneration may be performed when the impurity getting material is without or outside the impurity gettering container. In one embodiment, the regeneration may be performed in-line without removing the impurity gettering material from the impurity gettering container and without removing the impurity gettering device from its attached plumbing.

Water, ammonia, or potentially other impurities can be removed from fluids before they are placed in storage containers, such as tanks or cylinders. By removing water, the level of corrosion within the storage containers is reduced. Additionally, undesired reactions with water or oxygen (from the water) may be avoided. The method and system may be useful for HF storage, diatomic fluorine generators, fluorine-containing electrolytes for lithium ion or other batteries, and potentially other applications.

In one set of embodiments, a process for reducing a level of water in a halogen-containing fluid can comprise exposing the halogen-containing fluid to a fluorine-containing material. During the exposure, the fluorine-containing material can change from a first composition to a second composition. The process can further comprise flowing the halogen-containing fluid to a reactor after exposing the halogen-containing fluid to the fluorine-containing material.

In another set of embodiments, a process for reducing a level of an inorganic, polar, hydrogen-containing impurity from a process fluid can comprise exposing the process fluid to a solid fluorine-containing material. During the exposure, the fluorine-containing material can change from a first composition to a second composition that is a complex of the first composition. A ligand of the complex can comprise the impurity. The process can further comprise flowing the process fluid to equipment having sensitivity to the inorganic, polar, hydrogen-containing impurity after the process fluid has been exposed to the fluorine-containing material.

In still another set of embodiments, an impurity gettering device can comprise a container having an inlet, an outlet, and a material comprising a metal fluoride capable of forming a metal fluoride complex. The material may lie within the container and be configured such that a fluid may pass through the inlet and be exposed to the material before reaching the outlet.

In a further set of embodiments, a processing system can comprise an impurity gettering device coupled to a gas source, and a reactor coupled to the impurity gettering device. The impurity getting device can comprise a container having an inlet and an outlet and a material comprising a metal fluoride capable of forming a metal fluoride complex. The material may lie within the container and be configured such that a fluid can be exposed to the material before reaching the reactor.

The foregoing general description and the following detailed description are exemplary and explanatory only and are not restrictive of the invention, as defined in the appended claims.

### BRIEF DESCRIPTION OF THE DRAWINGS

The present invention is illustrated by way of example and not limitation in the accompanying figures.

FIG. 1 includes an illustration of a block diagram of a processing system that includes impurity gettering devices and reactors.

FIGS. 2-5 include illustrations of cross-sectional views of exemplary impurity gettering devices.

FIG. 6 includes an illustration of an electrolytic cell capable of generating diatomic fluorine.

FIG. 7 includes a process flow diagram for the formation, use, and regeneration of cobalt difluoride as an impurity gettering material.

FIGS. 8 and 9 include illustrations of cross-sectional views of an electronic device substrate before and after a process operation.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

An impurity gettering device can be installed between a source and a reactor to reduce an impurity from a fluid before it reaches the reactor. More particularly, the impurity gettering device can getter an inorganic, polar, hydrogen-containing impurity (e.g., water (H₂O), ammonia (NH₃), etc.) from a halogen-containing fluid (e.g., a fluorine-containing liquid or gas) by forming ligands to a metal-containing compound to form a complex. In one example, a fluid source may include HF and some H₂O. The HF and H₂O can flow through the impurity gettering device that includes cobalt difluoride (CoF₂). The CoF₂ can getter the H₂O and form a CoF₂ hydrate. After removing or at least reducing the level of H₂O in the fluid stream, the HF may become anhydrous HF that can be processed by a reactor, such as an electrolytic cell. By reducing the H₂O level before the fluid reaches the electrolytic cell, adverse effects of H₂O, such as consumption of a carbon anode, particle generation, etc. can be reduced.

The impurity gettering material may be regenerated by removing the ligand (e.g., H₂O or NH₃) from the complex. If the impurity is H₂O, the impurity gettering material may be dehydrated. The regeneration may be performed when the impurity getting material is without or outside the impurity gettering container. In one embodiment, the regeneration may be performed in-line without removing the impurity gettering material from the impurity gettering container and without removing the impurity gettering device from its attached plumbing.

A few terms are defined or clarified to aid in understanding the descriptions that follow. The term “complex” is intended to mean a coordinated compound that may have one or more coordinated groups called ligands. Examples of some ligands include H₂O, NH₃, and the like.

The term “interhalogen” in intended to mean a molecule whose elemental composition comprises at least two different halogens, wherein the molecule is exclusively halogens. For example, an interhalogen may be chlorine fluoride (ClF), chlorine trifluoride (ClF₃), bromine trifluoride (BrF₃), bromine pentafluoride (BrF₅), iodine pentafluoride (IF₅), or the like.

The term “polar,” when referring to an impurity or a material, is intended to mean a molecule having a dipole moment of at least 1.0.

The term “processing tool” is intended to mean a reactor in which substrates are capable of being processed.

The term “reactor” is intended to mean an apparatus where chemical bonds are changed (i.e., chemical bonds are formed, broken, or both). Examples include electrolytic cells, processing tools, and plasma generators.

As used herein, the terms “comprises,” “comprising,” “includes,” “including,” “has,” “having” or any other variation thereof, are intended to cover a non-exclusive inclusion. For example, a process, process, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present)

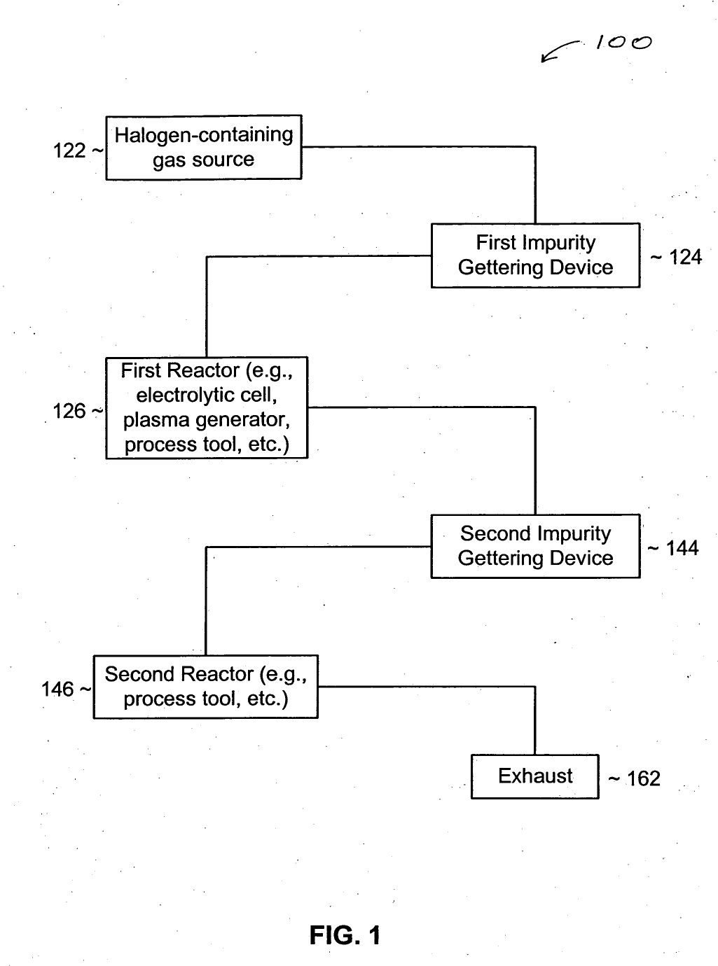

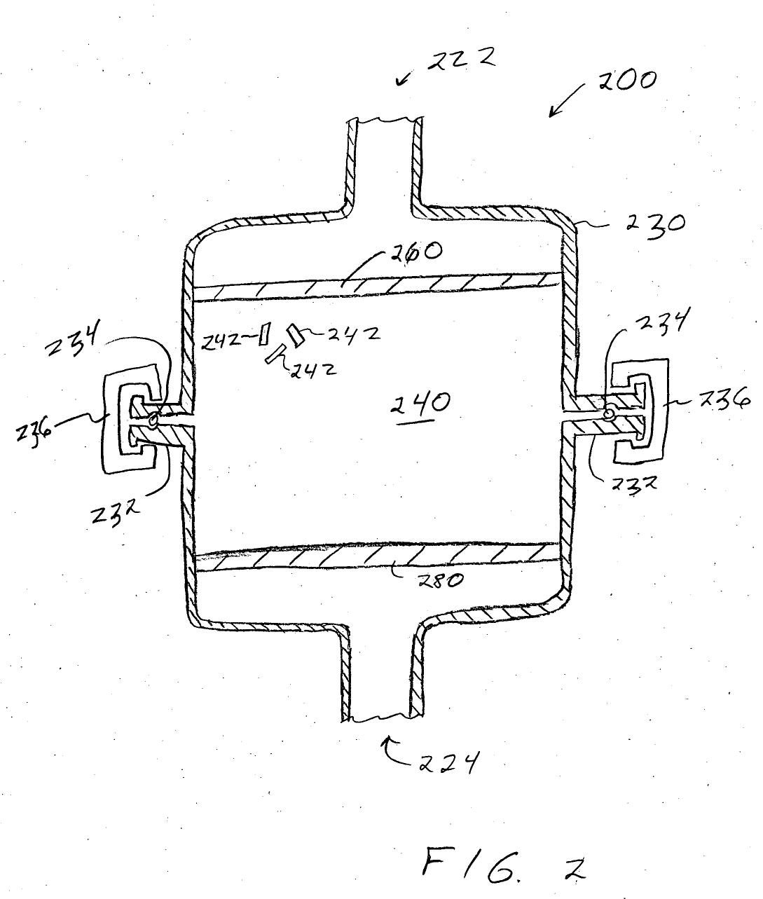

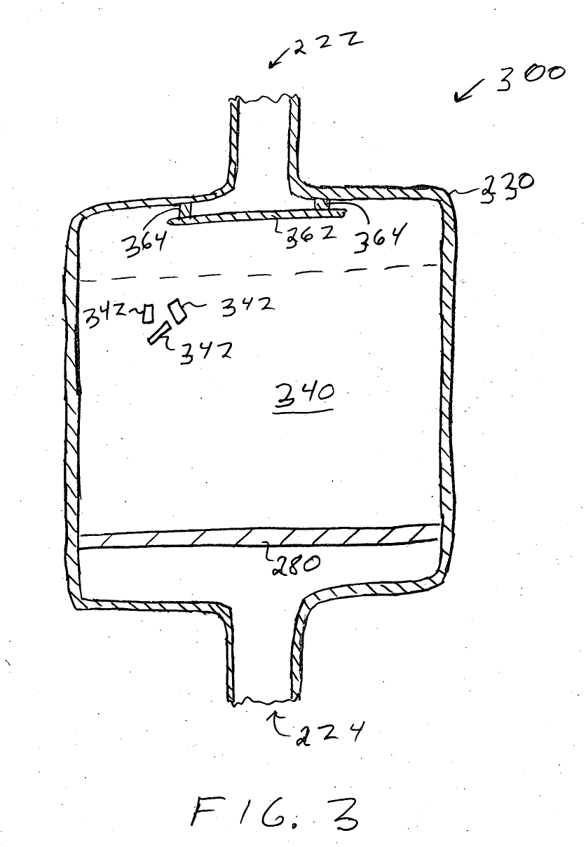

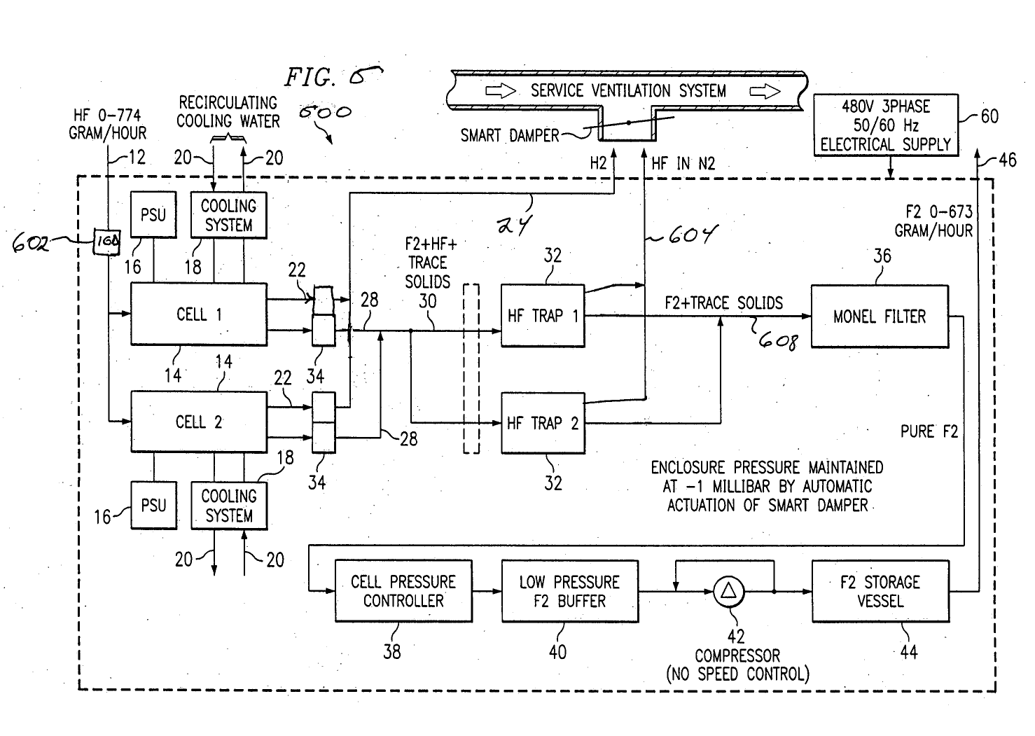

FIG. 1 includes a simplified block diagram of a processing system 100 that includes several components. A halogen-containing gas source 122 can be coupled to a first impurity gettering device 124. Examples of the first impurity gettering device 124 may include any of the devices as described and shown later in FIGS. 2-5. The first impurity gettering device 124 can be used to reduce the level of an inorganic, polar, hydrogen-containing impurity (e.g., H₂O, NH₃, or the like) within the halogen-containing gas. The first impurity gettering device 124 can be coupled to a first reactor 126. Examples of the first reactor 126 may include an electrolytic cell, a plasma generator, a processing tool (e.g., a deposition chamber, etcher, etc.), or the like. In one embodiment, an electrolytic cell as illustrated and described later in FIG. 6 may be used.

The first reactor 126 may be coupled to an optional second impurity gettering device 144. Similar to the first impurity gettering device 124, some potential designs are illustrated in FIGS. 2-5. The first and second impurity gettering devices 124 and 144 may be the same or different. Additionally, the impurity(ies) removed by the first and second gettering devices 124 and 144, respectively, may be the same impurity or may be different impurities. For example the first impurity gettering device 124 may remove H₂O, and the second impurity gettering device may remove NH₃.

The second impurity gettering device 144 may be coupled to an optional second reactor 146. The second reactor 146 may be a plasma generator, a processing tool, or the like. As shown in the processing system 100 in FIG. 1, the first and second reactors 126 and 146 are typically different reactors, however, they could potentially be the same type of reactor. The second reactor 146 may be coupled to an exhaust system 162. After reading this specification, skilled artisans will appreciate that many other configurations are possible.

FIG. 2 includes an illustration of a cross-sectional view of an impurity gettering device 200. The impurity gettering device has a container 230 with an inlet 222 and an outlet 224. The container 230 may be a two-piece canister, with each piece having a flange 232. An o-ring 234 may lie between the flanges 232, and a clamp 236 may be used to hold the pieces together. A gettering material 242 substantially fills the region between retainers 260 and 280 to form a packed bed 240. Note that many more particles of the gettering material 242 lie within the packed bed 240 than are shown in FIG. 2. Similarly, FIGS. 3-5 likewise include many particles of gettering material(s), only some of which are illustrated in the figures. More details regarding the gettering material 242 and retainers 260 and 280 are described later in this specification.

The container 230 may comprise a material that is relatively inert relative to any fluid (liquid or gas), impurity, or material designed to be used within the container 230. If the impurity gettering device 200 is to be used with a halogen-containing fluid that includes HF or F₂ gas, the container 230 may comprise Monel T™, Inconel™, nickel, copper, or a metallic alloy having at least 70 weight percent nickel, copper, or a combination of nickel and copper. Alternatively, the container may comprise platinum, gold, silver, aluminum, or the like. When HF or F₂ is used, stainless steel and other chromium containing alloys may be avoided because chromium may leach from the container 230. However, if other gases that are not as reactive with chromium (e.g., fluorocarbons, fluorohydrocarbons, nitrogen trifluoride (NF₃), sulfur hexafluoride (SF₆), and gases that do not include fluorine) are to have impurities removed, stainless steel may be used.

The gettering material 242 can have its composition changed when adsorbing an impurity from a fluid designed to flow through the device 200. In general, the material 242 may have a low vapor pressure, a high capacity for getting the impurity, not be significantly reactive with the fluid from which the impurity is to be removed, and be “non-mobile.” By non-mobile, the material 242 should stay within the container 200 while the fluid flows through the container. More specifically, the material 242 should not vaporize or generate small particles that can leave the container as small entrained particles with the fluid. The material 242 may be in the form of particles having a size in a range of approximately 1.5-4.5 mm (1/16-3/16 inch).

In an alternative embodiment, particles may include the material 242 coated onto a substantially inert matrix. The matrix may have a relatively high surface area to volume. Some non-limiting examples can include aluminum fluoride (AlF₃), calcium fluoride (CaF₂), polycrystalline Group IV A elements (carbon, silicon, etc.), and the like. Material 242 may have a particle size in a range of approximately 1.5-4.5 mm (1/16-3/16 inch).

In one set of embodiments, the material 242 may include a metal halide capable of forming a complex. When the impurity is exposed to the metal halide (a first composition), a hydrate or amine of the metal halide (a second composition) may be formed. In one particular example, CoF₂ may be used as the metal halide, and H₂O may be the impurity. When the fluid flows through the impurity gettering device 200, the CoF₂ may adsorb the H₂O and be converted to a hydrate of the CoF₂ (CoF₂ZH₂O), where Z is a whole number greater than zero, and for cobalt difluoride hydrates may be 2, 3, or 4. In this complex, the ligands include H₂O groups attached to the metal halide. Other materials may be used to form hydrates as illustrated below CuF₂(white)+2H₂O⇄CuF₂.2H₂O(blue)

FeF₃+3H₂O⇄FeF₃.3H₂O

NiF₂(white)+3H₂O⇄NiF₂.4H₂O(pink)

KF+ZH₂O⇄KF.ZH₂O, where Z=2 or 4

ZnF₂+4H₂O⇄ZnF₂.4H₂O

ZrF₄+4H₂O⇄ZrF₄.4H₂O

GeF₄(white)→Ge(OH)₂(orange)

Note that many materials exhibit a color change when becoming hydrated or dehydrated. The color change may be used to indicate when the gettering material should be regenerated or that regeneration is complete. The double-headed arrows show that at least some of the reactions are reversible. More details regarding the chemistry and regeneration are described later in this specific.

Thus, the fluid should have substantially none of the impurity gettered by the gettering material 242 when the fluid reaches the outlet 224. If device 200 is to remove H₂O from HF, anhydrous HF will flow though the outlet 224.

Within device 200, a retainer 260 overlies the packed bed 240 and another retainer 280 underlies the packed bed 240 to help keep the packed bed 240 in place. The shape of the gettering material 242 can include cylinders, spheres, or nearly any other shape.

The material for the retainers 260 and 280 should be relatively inert with respect to the fluid, impurity, and material 242 of the packed bed 240. The retainers 260 and 280 may include a sintered ceramic, such as alumina, aluminum nitride, silicon nitride, or the like. Alternatively a wire mesh may be used for the retainer 260, 280, or both. The wire mesh may include the same material as the container 230 or other metal-containing material that is relatively inert with respect to the fluid, impurity, and gettering material 242. In one non-limiting embodiment, the retainer 260 may have a relatively higher pressure drop across it compared the pressure drop from across the packed bed 240. In this manner, the retainer 260 may also be a flow distributor that more evenly distributes the fluid throughout the packed bed 240.

In still another embodiment, retainer 260, 280, or both may comprise a distributor plate with holes drilled through it (them) to allow the fluid to pass through the plate(s). In this embodiment, the diameters of the holes may be slightly larger as the distance from the center of the device 200 increases. After reading this specification, skilled artisans appreciate that many conventional techniques can be used to determine the size of openings through retainer 260 to achieve a relatively uniform flow through the packed bed 240. The size of the openings should not be greater than a diameter or width of the material 242.

As a fluid exits the outlet 224, the impurity level within the fluid should not be greater than approximately 10, and in some embodiments may be less than approximately 5 or even 1 ppm. The concentration may be monitored by measuring the conductivity of the exiting fluid. For example, if HF with small amounts of H₂O is passing through the impurity gettering device, the conductivity of the HF can be monitored to determine the amount of H₂O in the HF. The conductivity is a linear function of moisture content when a solution is 99.5 to 100% HF. Commercial HF may have 100-200 ppm. water, and typically, no more than 10 ppm is desired for some applications. Therefore, the conductivity meter works well at monitoring the water concentration in an HF stream. In one particular embodiment, a conductivity meter may be a Toroidal Conductivity Sensor Model Number 222, 225, or 228 available from Fisher-Rosemount Systems of Austin, Tex.

FIG. 3 includes an illustration of a cross-sectional view of an impurity gettering device 300. The device 300 is relatively similar to that shown in FIG. 2, except it has a single piece container 330 and flow distributor plate 362 to distribute the fluid as it enters the inlet 222. In one non-limiting embodiment, the gettering material 342 may be placed into the container 330 before it is welded shut. The distributor plate 362 can be attached to the container 230 by the attachment legs 364. The distributor plate may be solid or include holes extending through it. If the flow of the fluid through the device 300 is relatively laminar, the distributor plate 362 or an upper retainer (e.g., upper retainer 260 in FIG. 2) may not be needed, as the laminar flow may not significantly disturb the material 342 within the bed 340. The material 342 may be relatively dense compared to the fluid or may have a larger size compared to material 242, so that material 242 does not shift too much within the retainer 260. In still another embodiment, a sparger (not shown) may be used to introduce and distribute the fluid within the container 330.

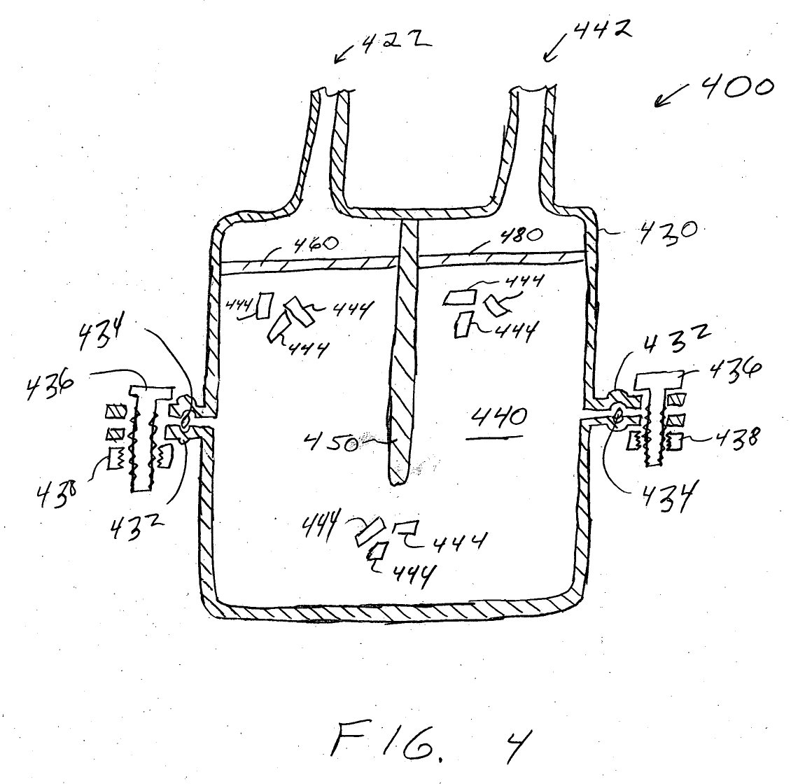

FIG. 4 includes an illustration of a cross-sectional view of yet another alternative impurity gettering device 400. In some instances, the inlet and outlet for the device may be made from the same side of the device. In this particular embodiment, the inlet 422 and outlet 442 are near the top of FIG. 4. The device 400 can include a packed bed 440 of a material 444. The material 444 can be any of those materials previously discussed for material 244. This particular embodiment includes retainers 460 and 480 similar to retainers 260 and 280 as seen in FIG. 2.

The device 400 can include a baffle 450 attached to the container 430 to help direct the fluid flow through the packed bed 440. In this particular embodiment, the container 430 can be a two-piece container similar to the device 200 illustrated in FIG. 2. The container 430 in FIG. 4 has bolt holes extend through the flanges 432. The flanges 432 can be held together by bolts 436 and nuts 438. Optionally, washers (not shown) may be used with the bolts 436 and nuts 438. An o-ring 434 can be used to help the integrity of the seal with respect to the fluid that will pass through the device 400.

The fluid may flow through the inlet 422, the first retainer 460, and then the left-hand portion of the bed 440 as seen in FIG. 4. The fluid can continue by flowing under the baffle 450, and through the right-hand portion of the bed 440, the retainer 480, and outlet 442. In other embodiments (not shown), other baffles, flow distributors, or other flow altering mechanisms may be used to improve the contact of the fluid with the material width in the bed. In one specific embodiment, baffles can be used to achieve a serpentine flow through the device to increase the linear travel of the fluid through the device without significantly increasing the volume of the device.

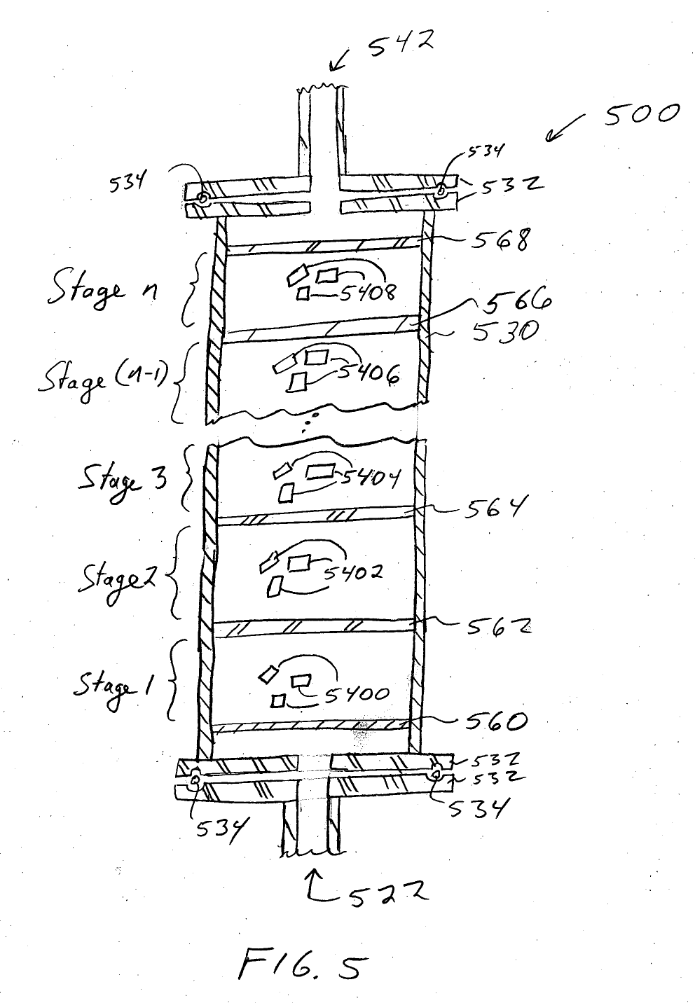

FIG. 5 includes an impurity getting device 500 that has a plurality of stages. The device 500 comprises an inlet 522, an outlet 542, flanges 532, and o-rings 534. The device further comprises a cylindrical container 530 attached to the flanges 532 using a conventional technique. The composition of the cylinder 530 has similar material compatibility constraints as previously described with respect to container 230.

The device 500 further includes retainers 560, 562, 564, 566, and 568 that can be used to separate the device 500 into stages, such as Stage 1 to Stage n as shown in FIG. 5. Virtually any finite number of stages can be used. The stages in device 500 may be used to remove different impurities, have gettering materials of different compositions, an indicator, or any combination thereof. Therefore, the materials 5400, 5402, 5404, 5406, and 5408 can be gettering materials, indicators, or potentially serve other functions. For example, material 5400 may comprise CoF₂ and is to getter H₂O, and material 5408 may comprise CoF₃ or CuF₂, both of which undergo color changes upon hydration, which is to indicate if too much H₂O is in the effluent.

In general, an indicator can be placed downstream of a stage that is designed to remove an impurity. Note that another gettering material and indicator may be used for a different impurity, such as NH₃. The gettering material and indicator may comprise the same compound. If the cylinder 530 is optically transparent, an operator or photodetector may be used to determine if the indicator indicates that regeneration should be performed.

FIG. 6 includes an illustration of a fluorine generating system 600 that can be used in conjunction with an impurity gettering device, such as any of those previously described. This particular system 600 is designed to receive HF as an input and produce diatomic hydrogen (H₂) and F₂. The F₂ can be used in further or processing operations, such as in a plasma generator to generate a fluorine plasma or may be used without a plasma and be fed directly into a processing tool. Although not shown, each of the electrolytic cells 14 (Cell 1 and Cell 2) typically includes a carbon anode. The carbon anode should have a significantly longer lifetime since the carbon anode will not be consumed nearly as fast due to incoming H₂O within HF stream because most of the H₂O can be removed by the impurity gettering device (“IGD”) 602 before reaching the electrolytic cells 14.

Attention is directed to a more detailed description of an exemplary, non-limiting embodiment of the fluorine generating system 600 as shown in FIG. 6. The system 600 can include raw material HF input supply line 12, IGD 602, and electrolytic gas generation cells 14. The IGD 602 can remove impurities before the gas reaches the electrolytic gas generation cells 14. During operation of the gas generation cells 14, diatomic hydrogen (H₂) may be generated at one electrode (cathode) of the electrolytic cell, and F₂ may be generated at the other electrode (anode) of the electrolytic cell. The electrodes may comprise carbon blades. Because the impurity level of H₂O within the HF has been reduced by IGD 602, the generation of oxygen, and therefore, the consumption of the carbon anode will be reduced compared to a conventional technique. The electrolyte within gas generation cells 14 can include potassium fluoride (KF.2HF)

Each gas generation cell 14 can be coupled to a pressure-sensing unit 16 and a cooling system 18. Pressure sensing unit 16 monitors the pressure within a process generation cell 14. Cooling system 18 provides cooling to its respective gas generation cell 14 using recirculating cooling water through cooling water lines 20.

The diatomic hydrogen from each gas generation cell 14 can flow to the hydrogen output lines 22. A hydrogen output header 24 can be coupled to and receive hydrogen from each hydrogen output line 22. Hydrogen output header 24 can be coupled to exhaust system 25, so that hydrogen may be routed to exhaust system 25 and then to service ventilation system 26, which exhausts the hydrogen from the area.

The F₂ gas, including small amounts of HF and solids, can be output from gas generation cells 14 along gas output lines 28 to a combined gas output header 30. Each gas generation cell 14 can further comprise an output manifold 34. The F₂ can flow through an output manifold 34 and to a combined gas output header 30. The gas generation system 600 can further comprise various valves operable in various open/closed combinations, to direct gas from each manifold 34 to one or another (or to multiple) HF traps 32. The HF traps 32 can include sodium fluoride and can used to remove residual HF from the gas stream. Although FIG. 6 shows only two HF traps 32, other embodiments can comprise multiple NaF traps. In operation, one HF trap 32 can always be on-line, and the other HF trap 32 (or other ones) regenerating or being maintained. During regeneration, HF can be emitted from the trap(s) 32 and be directed to a ventilation system via HF exhaust line 604.

During normal operation, the output of HF traps 32 in lines 608 includes. F₂ gas, including a small amount of solids. This gas stream flows to a Monel output filter 36 to remove the remaining solids, if any. Because IGD 602 removed H₂O before reaching the cells 14, the level of particulates, such as carbon oxyfluorides and sulfur oxyfluorides, and the like, within lines 608 should be reduced. Therefore, a longer time may pass before the filter 36 needs to be cleaned or replaced. The effluent from filter 36 should be substantially all F₂ gas. The filtered gas may be sequentially forwarded to cell pressure controller 38 and then to low-pressure buffer tank 40. Cell pressure controller 38 can cycle gas generation cells 14 on and off based on gas demand as measured at the input to low-pressure buffer tank 40.

After tank 40, the F₂ gas can be provided to compressor 42. Compressor 42 can be coupled to a low-pressure buffer tank 40 and, at its output, to gas storage tank 44. Compressor 42 can compress the F₂ gas to, for example, approximately 100 kPa (or 15 psig) in gas storage tank 44. From gas storage tank 44, the gas can be provided via the output line 46 to another reactor, such as a plasma generator, a processing tool, or the like. An exemplary processing tool may include a deposition chamber, an etch chamber, or the like. In one embodiment, the gas can be fed to an external or remove plasma generator, where a fluorine plasma generated and its effluent may then be fed to a processing tool.

The generator 600 illustrated in FIG. 6 is exemplary of just one reactor capable of producing F₂ gas. After reading this specification, skilled artisans appreciate that many other alternatives may be used.

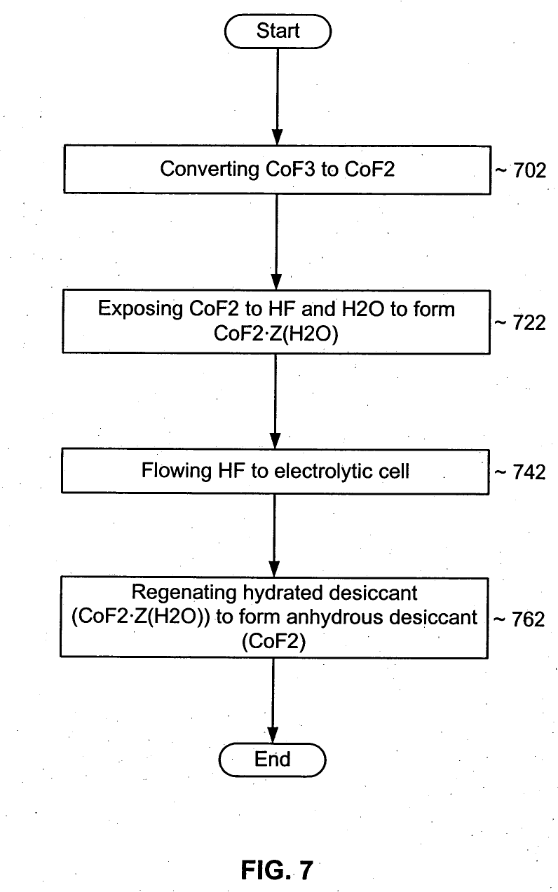

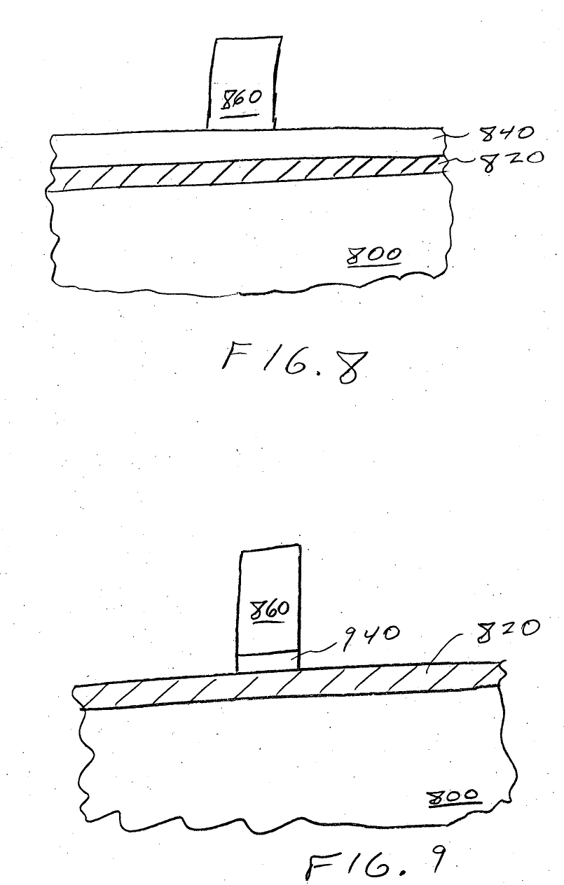

FIG. 7 includes a process flow diagram for one specific, non-limiting embodiment. In this particular embodiment, CoF₂ can be used to remove H₂O from an HF gas stream. Commercially available sources can be used to obtain cobalt trifluoride (CoF₃). Cobalt trifluoride is relatively more stable compared to CoF₂, and therefore, is typically easier to store and transport.

Referring to FIG. 7, the process can comprise converting CoF₃ to CoF₂ (block 702). The process can also comprise exposing CoF₂ to HF and H₂O to form CoF₂.Z(H₂O) (block 722). The process can further comprise flowing HF to electrolytic cell (block 742). The process can still further comprise regenerating hydrated desiccant (CoF₂.Z(H₂O)) to form anhydrous desiccant (CoF₂) (block 762). Each block in FIG. 7 is described in more detail below.

Regarding the conversion in block 702, the conversion may occur by reacting the CoF₃ with diatomic hydrogen, carbon dioxide, or another reducing agent. The conversion may be performed at a temperature in a range of approximately 150-200° C. and at substantially atmospheric pressure for a time in a range of approximately 1-2 hours. Temperatures, pressures, and times may be higher or lower than those given. If the temperature, pressure, time, or any combination of them is too small, the conversion may be incomplete. If the temperature, pressure, or time is too great, other issues not direct related to the conversion reaction may be a concern. For example, if the temperature or pressure is too high, special equipment may be needed. If the time is too long, throughput may suffer. CoF₃ has a tan brown color and CoF₂ has a pink color. If desired, an optical viewport may be used during the conversion to examine the color.

The CoF₂ can be used as a gettering material within any of the impurity gettering devices shown in FIG. 2-5. Referring to FIG. 6, IGD 602 may be installed before the cells 14. In one embodiment, water can be removed from the HF before it gets near the cells 14. For example, the water may be removed from the HF soon after it is formed but before it is stored in a tank or gas cylinder. By removing the water before storing, the corrosiveness of the HF is reduced (due to less water) and may allow a wider variety of materials (e.g., iron-containing materials) to be used for storing HF. Alternatively, the water may be removed just before the HF reaches the cells 14 or at nearly any point in between storage and the cells 14. The installation may be performed using a conventional technique.

After installing the impurity gettering device, the process can also comprise exposing the CoF₂ to the HF and H₂O to form a CoF₂ hydrate (CoF₂.ZH₂O) (block 722). Z may increase as more H₂O is adsorbed onto the gettering material. The exposure can be performed at a temperature in a range of 19-70° C. and a pressure in a range of approximately 0-350 kilopascals (0-50 pounds per square inch) gauge for a time (residence time) in a range of approximately 0.1-9.0 minutes. The HF and H₂O may be in a vapor or liquid phase. In the vapor phase, temperature may be as high as 100° C. When the temperature is too high or too low, the absorption rate may be too low. In one embodiment, 60° C. may be used. The exposure time may depend on the temperature. If the time is too short, the outlet may contain too much water. Long times are not a theoretical limitation on the chemistry but can be a throughput issue. In the liquid phase, solubility may be a concern. The solubility of CoF₂ in liquid HF at room temperature is approximately 0.0036 g CoF₂/100 g HF. Conversely, the solubility of CoF₂ in HF vapor at room temperature is substantially zero.

Many of the complexes formed can include different colors if different hydrates (monohydrate, dihydrate, trihydrate, etc.) are formed. In one particular embodiment, the monitoring of the CoF₂ hydrates may be achieved by using an illumination source and detector to determine the color of the impurity gettering material. CoF₂ may have a substantially pink color and CoF₂.4H₂O may have a substantially red color. As more H₂O groups become ligands attached to the CoF₂, color changes can occur. The color change can be used to as an indicator determine when the impurity gettering material has been spent and needs to be regenerated.

Viewport(s) (not shown) can used with the container of the impurity gettering device to allow radiation (e.g., light) to be introduced and detected outside of the impurity gettering device. The detection may be performed by a human or may be performed using a detector (e.g., a photodetector coupled to a processor or computer). The radiation used may be any one or more frequencies within the visible light, infrared, or ultraviolet spectrum. The viewport should be substantially transparent to the radiation used. For visible light radiation and HF as the fluid, the viewport may comprise calcium fluoride (CaF₂), aluminum nitride (AlN), or the like. In one embodiment, the cylinder 530 of the impurity gettering device 500 may be transparent or translucent to the radiation. For example, cylinder 530 may comprise polytetrafluoroethylene (PTFE), polyvinylidene fluoride (PVDF), fluorinated ethylene propylene (FEP), perfluoralkoxide (PFA), polychlorotrifluoroethylene (PCTFE), or the like. Many of these materials are available under a variety of trade names from E. I. DuPont de Nemours & Company of Wilmington, Del., 3M Company of St. Paul, Minn., and potentially other companies. Although many of these materials are not optically transparent, they can be optically translucent, and thus, color changes of a material within cylinder 530 can still be detected.

The process can further include flowing the HF to an electrolytic cell (block 742). Although not shown in FIG. 6, an optional conductivity monitor, such as the one previously described, may be used to monitor H₂O content with in HF. The conductivity meter may be installed between the IGD 602 and the cells 14. After a predetermined time or amount of H₂O has been adsorbed, the CoF₂ hydrate may need to be regenerated.

The process can still further comprise regenerating the hydrated desiccant (e.g., CoF₂.ZH₂0) to form anhydrous desiccant (e.g., CoF₂) (block 762). The regeneration can occur as a dehydration (using an anhydrous inert gas, heat, or both) or as a chemical reaction. Below is one exemplary reaction. After reading this specification, skilled artisans appreciate that other hydrates can be used and regenerated in a similar manner.
CoF₂.ZH₂O+ZF₂→CoF₂+2ZHF+½ZO₂

For dehydration, the regeneration may be performed at a temperature in a range of approximately 120-190° C. using one or more relatively inert gases under subatmospheric pressure for a time in a range of approximately 1-2 hours. Examples of the relatively inert gases include nitrogen, argon, helium, etc. As the temperature decreases or the pressure increases, the dehydration rate goes down. If the time is too short, not enough water may be removed. Long times are not a theoretical limitation but can be a throughput issue. A gravimetric method (i.e., weighing) can be used to determine when sufficient water is removed from the desiccant. Alternatively, a color change may be used to determine when regeneration is complete. In one particular set of embodiments, the regeneration can be performed while the gettering material remains within the container of the impurity gettering device.

For a chemical reaction similar to the one described above, the hydrated desiccant can react with fluorinating agent, such as diatomic fluorine, at a temperature in a range of approximately 250-300° C. at substantially atmospheric pressure for a time in a range of approximately 1-2 hours. The ambient may include 2-100% of the diatomic fluorine. The temperature, pressure, and time of the reaction may be less than or greater than those listed above. If some of the CoF₂ is converted to CoF₃ during the regeneration, the CoF₃ can be converted to CoF₂ using the conversion process previously described with respect to block 702 in FIG. 7.

Optionally, a relatively inert gas may flow through the container during the regeneration to help remove the impurity from the impurity gettering device. After reading this specification, skilled artisans are capable of determining the temperature and time for regeneration depending on the composition and amount of gettering material. When the dehydration is substantially complete, the inlet and outlet of the device may be sealed so that it can be transported to its location where it will be used without adsorbing a significant amount of H₂O from atmosphere.

After regeneration and optional conversion, the anhydrous desiccant can be used as an impurity getter to remove water (block 722). The process may be iterated many times.

Embodiments may be used to remove NH₃ similar to H₂O. Similar to H₂O, NH₃ can form a metal hydride complex. In this particular embodiment, the ligands will be NH₃ groups instead of H₂O groups. In such an embodiment, the NH₃ can be adsorbed and form an amine complex. A subsequent regeneration step can be used to remove the NH₃ from the complex so that the impurity gettering material can be reused again.

In still other embodiments, impurities can be removed from gases commonly used in industry. H₂O may need to be removed from processing gases before using the gases in a manufacturing facility. FIG. 8 includes an illustration of a cross-section view of an electronic device substrate 800, a dielectric layer 820, and a conductive layer 840. The conductive layer 840 may need to be patterned to define a gate or capacitor electrode. A patterned resist layer 860 may be formed over the conductive layer 840 at a location where the conductive layer 840 is to remain after etching. Typically, the resist layer 860 comprises an organic material. The electronic device substrate including the resist layer 860 may be placed within a plasma reactor, such as a plasma etch chamber. The patterned resist layer 860 may have an initial thickness of approximately 800 nm and a width of approximately 200 nm.

A fluorine-containing gas comprising nitrogen trifluoride (NF₃), sulfur hexafluoride (SF₆), hydrogen bromide (HBr), F₂, a fluorocarbon (e.g., carbon tetrafluoride (CF₄)), HF, any combination thereof, or the like may be used. The fluorine-containing gas(es) should not include any oxygen, such as in the form of H₂O, to reduce potential erosion of the patterned organic resist layer and keep fluorine lifetimes in the reactor relatively high and more controlled. The impurity gettering device, such as any previously described, may be used to reduce the level of H₂O within any or all of the fluorine-containing gas(es).

After impurity removal, the fluorine-containing plasma can be generated from the fluorine-containing gas(es) and used to etch the conductive layer 840. During the etching, exposed portions of the conductive layer 840 and the patterned organic resist layer 860 are exposed to the fluorine-containing plasma to form the conductive member 940 as seen in FIG. 9. The amount of resist erosion may be less because the level of oxygen within the plasma is low. Thinner resist layers may be used without having to worry about consuming too much of the resist layer during the etch. Also, the dimensions of the conductive member 940 may be closer to the originally printed dimension of the resist layer 860.

In other embodiments, the impurity gettering device may be used to remove H₂O for clean dry air used in pneumatic controls at a manufacturing facility. In another example, the impurity gettering device may be used to remove an impurity (e.g., H₂O, NH₃, or the like) from a different halogen-containing gas (e.g., diatomic chlorine (Cl₂), hydrogen chloride (HCl), diatomic bromine (Br₂), hydrogen bromide (HBr)) a relatively inert gas, such as a noble gas (helium, neon, argon, xenon), diatomic nitrogen (N₂), carbon dioxide (CO₂), or the nearly any other gas.

In yet other embodiments, impurities may be removed from liquids using an impurity gettering device. In some embodiments, a gas may be compressed into a liquid before passing it through the impurity gettering device. In still another embodiment, the impurity gettering device may be used to remove H₂O from a hygroscopic fluid, such as hydraulic fluid. For example, the impurity gettering device may be used to remove H₂O from brake fluid to allow reuse of previously spent brake fluid that has too much H₂O.

In still another embodiment, the impurity gettering device can be used to remove H₂O from an electrolyte before the electrolyte is used in a battery, and particularly a lithium battery. The H₂O removal benefits extended battery life by reducing decomposition of the lithium hexafluorophosphate electrolyte and resultant HF release and subsequent internal cell corrosion.

Referring to FIG. 6, IGD 602 can be replaced by a pair of IGDs configured in parallel. Similar to the traps 32, one IGD may be regenerated while the other IGD is operating to remove H₂O from the HF. The regeneration may be performed in-line (i.e., without having to remove the IGD from its adjacent plumbing) with additional plumbing (not shown), or the IGD may be removed and placed in a furnace or other heat source to help dehydrate the metal halide.

Many of the embodiments have advantages over conventional systems and processes. The impurity gettering devices described herein are particularly well suited for removing H₂O from a fluorine-containing gas or liquid, such as HF. HF is reactive with many compounds, so the ability to use a material that getters H₂O without reacting with the HF and doing so before reaching a reactor provides an advantage not seen with conventional systems. A conventional system using KF salt within an electrolytic cell does not prevent H₂O from entering the cell. The embodiments described herein can be used to reduce water or ammonia content within a fluid stream to less than 10 ppm and potentially below 1 ppm.

The system should be useful for all fluorine-containing gases including interhalogens (e.g., ClF, ClF₃, BrF₃, BrF₅, IF₅, or the like), HF, F₂, and other relatively reactive fluorine compounds. The system can be-used for many other gases as previously mentioned.

The impurity gettering device is relatively straightforward to make and implement. Therefore, it can be implemented within a manufacturing process without a lot of risk. A parallel implementation of impurity getting devices can allow the ability to remove an impurity without having to shut down an apparatus, which can be vital to continuous manufacturing operations. Also, the impurity gettering device can be used after a chemical compound is formed to remove water, ammonia, or other impurities before the chemical compound is stored, packaged, or distributed.

The impurity gettering devices can remove impurities at a processing tool or immediately before it. By using the devices within or near the processing tool, an impurity introduced between a source (gas cylinder or tank) to the impurity gettering device, including fittings and potentially long lengths of tubing, may be removed even though the fluid within the gas cylinder may be sufficient purity. The impurity gettering devices can help to reduce tool-to-tool and source-to-source (e.g., different gas cylinders or different shipments to a tank) process variations.

The gettering material for the impurity gettering device can be regenerated, and therefore, is recyclable. In theory, after paying for the gettering material one time, it can be regenerated and reused an infinite number of times. Also, in some embodiments, the regeneration may be performed without having to disassemble the device's container and may potentially be performed in-line.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

1. A process for reducing a level of H₂O in a halogen-containing fluid comprising:
exposing the halogen-containing fluid to a fluorine-containing material, wherein during exposing, the fluorine-containing material changes from a first composition to a second composition; and
flowing the halogen-containing fluid to a reactor after exposing the halogen-containing fluid to the fluorine-containing material.

2. The process of claim 1, wherein:
the first composition comprises a metal-fluorine compound;
the second composition comprises a hydrate of the metal-fluorine compound;
the halogen-containing fluid comprises HF; and
the reactor comprises an electrolytic cell.

3. The process of claim 1, wherein the material:
is not substantially soluble in the presence of the halogen-containing fluid;
is capable of being regenerated from the second composition to the first composition; and
has a particle size in a range of approximately 1.5-4.5 mm.

4. The process of claim 1, further comprising regenerating the material from the second composition to the first composition, wherein exposing and regenerating are performed, while the material lies within a same container.

5. The process of claim 1, wherein:
the halogen-containing fluid comprises HF;
the first composition of the material is CoF₂;
the second composition comprises a hydrate of CoF₂; and
the reactor comprises an electrolytic cell that is designed to generate F₂ from HF.

6. The process of claim 1, further comprising monitoring a conductivity of the halogen-containing fluid after exposing the halogen-containing fluid to the fluorine-containing material.

7. The process of claim 1, further comprising placing the halogen-containing material in a storage container after exposing the halogen-containing fluid to a fluorine-containing material and before flowing the halogen-containing fluid to a reactor.

8. The process of claim 1, wherein the reactor is a lithium ion battery.

9. A process for reducing a level of an inorganic, polar, hydrogen-containing impurity from a process fluid comprising:
exposing the process fluid to a solid fluorine-containing material, wherein:
during exposing, the fluorine-containing material changes from a first composition to a second composition that is a complex of the first composition; and
a ligand of the complex comprises the impurity as a coordinating group;
flowing the process fluid to equipment having sensitivity to the inorganic, polar, hydrogen-containing impurity after exposing the process fluid to the fluorine-containing material.

10. The process of claim 9, wherein:
the first composition comprises a metal-fluorine compound; and
the impurity comprises H₂O or NH₃.

11. The process of claim 9, wherein the material:
is not substantially soluble in the presence of the process fluid;
is capable of being regenerated from the second composition to the first composition; and
has a particle size in a range of approximately 1.5-4.5 mm.

12. The process of claim 9, further comprising regenerating the material from the second composition to the first composition, wherein exposing and regenerating are performed while the material lies within a same container.

13. The process of claim 9, wherein:
the process fluid comprises HF;
the first composition of the material is CoF₂;
the second composition comprises a hydrate of CoF₂; and
the reactor comprises an electrolytic cell.

14. The process of claim 9, further comprising monitoring a conductivity of the fluorine-containing fluid after exposing the fluorine-containing fluid to the fluorine-containing material.

15. The process of claim 9, wherein after exposing, the concentration of the H₂O within the process fluid is no greater than approximately 10 parts per million.

16. An impurity gettering device comprising:
a container having an inlet and an outlet; and
a first material comprising a first metal fluoride capable of forming a first metal fluoride complex, wherein the first material lies within the container and configured such that a fluid passes through the inlet and the first material before reaching the outlet.

17. The impurity gettering device of claim 16, wherein the first metal comprises cobalt.

18. The impurity gettering device of claim 16, further comprising a second material and a retainer, wherein:
the retainer lies between the first and second materials;
the second material lies between the retainer and the outlet; and
the second material is capable of changing color when exposed to an impurity that the impurity gettering device is designed to getter.

19. The impurity gettering device of claim 16, wherein the container comprises at least 70 weight percent of nickel, copper, or a combination of nickel and copper.

20. The impurity gettering device of claim 16, wherein at least a portion of the container is optically transparent or translucent.

21. A processing system comprising:
an impurity gettering device coupled to a fluid source,
wherein the impurity getting device comprises:
a container having an inlet and an outlet; and
a first material comprising a first metal fluoride capable of forming a first metal fluoride complex, wherein the material lies within the container and configured such that a fluid passes through the inlet and the material before reaching the outlet; and
a first reactor coupled to the impurity gettering device.

22. The processing system of claim 21, wherein the first metal comprises cobalt.

23. The processing system of claim 21, wherein the impurity getting device further comprises a second material and a retainer, wherein:
the retainer lies between the first and second materials;
the second material lies between the retainer and the outlet; and
the second material is capable of changing color when exposed to an impurity that the impurity gettering device is designed to getter.

24. The processing system of claim 21, wherein the container comprises at least 70 weight percent of nickel, copper, or a combination of nickel and copper.

25. The processing system of claim 21, wherein at least a portion of the container is optically transparent or translucent.

26. The processing system of claim 21, wherein the first reactor comprises an electrolytic cell.

27. The processing system of claim 21, further comprising a second reactor coupled to the first reactor, wherein:
the first reactor comprises a plasma generator; and
the second reactor-comprises a semiconductor fabrication tool.

28. The processing system of claim 21, wherein the first reactor comprises a deposition chamber.
